(19) United States
(12) Patent Application Publication
(10) Pub. No.: US 2020/0095107 A1
(43) Pub. Date: Mar. 26, 2020

(54) Handheld Puncturing Tool

(71) Applicant: Justin Durry Niebergall, Redmond, WA (US)

(72) Inventor: Justin Durry Niebergall, Redmond, WA (US)

(21) Appl. No.: 16/139,081

(22) Filed: Sep. 23, 2018

(51) Int. Cl. B67B 7/00; B67B 7/16; B67B 7/44

(52) U.S. Cl. CPC B67B 7/24; B67B 7/44; B67B 7/16

(57) ABSTRACT

A handheld puncturing tool which may be used as a hand-operated puncturing tool for puncturing a container or opening a bottle. An individual's hand motion and action of piercing and pressing through a container with a handheld puncturing tool may be fast and easy for the individual. At one end of a handheld puncturing tool, a claw-shaped prong protrudes. And, protruding along the elongated body of a handheld puncturing tool may be a first sharp-ended tooth prong and a second sharp-ended tooth prong. With the sharp-ended prongs and the light weight of the handheld puncturing tool, an individual may easily operate the handheld puncturing tool to puncture a container and create a venting hole which directs airflow into the container, which reduces any vacuum effect potentially caused when the second sharp-ended tooth prong pierces the container.

### FIELD

This disclosure generally relates to a handheld puncturing tool.

### BACKGROUND

Various types of containers, such as cans and boxes with relatively flat tops and bottoms, are used to preserve beverages or other liquid food products. With modern efforts to become more self-sustainable, these types of containers may be used to supply food and beverages to military, police, or other emergency and rescue service providers. Individual consumers may also purchase their foods and beverages packaged in these containers, for example, soft drinks, tomato juice, soda water, beer, wine, or soup broth. Consuming contents from these containers presents some challenges to individuals who wish to rapidly drink or drain the contents of the containers. For example, an individual may want to rapidly drink a beverage directly from the container, but discover the flow of liquid is restricted, even after opening the container. This tendency of a restricted flow leads to increased time to empty or rapidly consume the contents of these containers.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a handheld puncturing tool, developed from materials that may be useful for puncturing and draining containers. A handheld puncturing tool may be made from a variety of materials, such as metals, wood, or hard plastics.

An embodiment of a handheld puncturing tool may be made of a single piece of lightweight material with various shaped prongs, such as a hook-shaped prong capable of being used to pop off a bottle cap from a bottle, a claw-shaped prong capable of griping a top or bottom end of a container, at least one handle area for individual users to take hold of handheld puncturing tool, and at least one sharp-ended tooth prong capable of piercing and puncturing the wall of a metal container, and may also have a second sharp-ended tooth prong capable of piercing and puncturing the wall of a metal container.

A handheld puncturing tool may be made of a single piece, or multiple pieces, of aluminum metal, stainless steel metal, a blend of metals, or hard plastic. In one embodiment of a handheld puncturing tool, one or more handle areas may be constructed from the same piece of material as the other parts of the handheld puncturing tool, and or some of the handle areas may be coated with another material, such as wood or rubber. Coating handheld areas with another material, such as wood or rubber, may improve the grip for an individual using the handheld puncturing tool, since a handheld puncturing tool is a hand operated mechanical tool. Embodiments of a handheld puncturing tool may be used to puncture and drain containers, and they may also be used to open bottles. The handheld puncturing tool may be constructed as a combination tool embodiment, capable of bottle opening and container puncturing, which would enable an individual to use the handheld puncturing tool for opening a bottle and puncturing a container.

A handheld puncturing tool is not limited to one size. An embodiment of a handheld puncturing tool may be constructed to fit and puncture a variety of containers. The handheld puncturing tool may be constructed to puncture containers of various lengths, with relatively flat top or bottom surfaces. Embodiments of the handheld puncturing tool may make it extremely easy to open a container without requiring too much force or agility, given its relatively light weight and compact size. The handheld puncturing tool may be a powerful and safe tool to use.

A handheld puncturing tool, as previously mentioned, may be constructed to have a claw-shaped prong, that may be located at one end of handheld puncturing tool, which may be used to grip to one relatively flat end of a container. Examples of containers with relatively flat ends are soda cans, juice boxes, wine boxes, beer cans, broth boxes or cans. A handheld puncturing tool, as mentioned above, may have a first sharp-ended tooth prong that may project out along one side of the handheld puncturing tool, in alignment with the claw-shaped prong and it may be located near and below the claw-shaped prong.

When an embodiment of handheld puncturing tool, consisting of a first sharp-ended tooth prong and a second sharp-ended tooth prong, is used the individual may operate the handheld puncturing tool such that the first sharp-ended tooth prong punctures a container to create a venting hole which directs airflow into the container, this hole may reduce a vacuum effect, when individual operates the handheld puncturing tool causing a second sharp-ended tooth prong to pierce the container. The second sharp-ended tooth prong may be a sharp prong that projects from the handheld puncturing tool and is in alignment with and below the first sharp-ended tooth prong. An individual's hand motion and action of piercing and pressing through the container with a handheld puncturing tool is fast and easy for the individual.

Both the first sharp-ended tooth prong and the second sharp-ended tooth prong may have sharp cutting points that leave a smooth-edged opening in a container after they are pressed into the container, and subsequently removed from the container. The distance between the first sharp-ended tooth prong and the second sharp-ended tooth prong may vary depending on the size of a container. The length of the handle areas of handheld puncturing tool will vary according to that distance. Embodiments of a handheld puncturing tool may be designed and constructed to fit various containers.

The handheld puncturing tool may be constructed, such that it may be light enough to be used with one hand. Embodiments of a handheld puncturing tool may be constructed from materials that are useful for piercing and puncturing containers made of different materials, such as metal, cardboard paper, or plastic.

Individuals may use a handheld puncturing tool to puncture a container to drain its contents. An individual may follow a sequence of steps in progression to ultimately puncture and drain a container. First, an individual takes hold of a container that is to be punctured in one hand, exposing the surface of the container which will be punctured to enable draining. Next, while the individual firmly holds in their hand the container, they grab and hold a handheld puncturing tool, which fits the container, on the other hand. Following that, the individual proceeds to get ready to puncture the container. The individual, while holding the container in one hand, with their hand wrapped around and covering the surface of the container that will not be punctured, exposing the surface of the container where the pierce and punctures will be, then applies with the individual's other hand the claw-shaped prong end of the handheld puncturing tool to meet and grip the top surface of the container, hooking the claw-shaped prong end of the handheld puncturing tool to the top surface of container. At this stage of the progression, the container's top surface is gripped with the claw-shaped prong end of the handheld puncturing tool, and the handheld puncturing tool is near but tilted up away from the exposed surface of the container. Next, the individual proceeds to rotate the handheld puncturing tool towards the exposed surface, by rotating from the claw-shaped prong end, moving the bottom-end of the handheld puncturing tool down towards the exposed surface of the container. As the individual continues pressing the bottom-end of handheld puncturing tool down, the first sharp-ended tooth prong and the second sharp-ended tooth prong both puncture the exposed surface of the container.

Eventually, the contents of the container flow out smoothly from the opening created by the second sharp-ended tooth prong. The opening created by the first sharp-ended tooth prong creates a venting hole which directs airflow into the container, thereby reducing a potential vacuum effect, and allowing for a smoother pour.

### BRIEF DESCRIPTION OF THE DRAWINGS

FIG. 1 illustrates a block diagram of one aspect of one embodiment of a handheld puncturing tool.

FIG. 2 illustrates one flow chart for the use of a handheld puncturing tool.

FIG. 3 illustrates a block diagram of one embodiment of a handheld puncturing tool as it may be used.

FIG. 4 illustrates a block diagram of one embodiment of a handheld puncturing tool as it may be used.

FIG. 5 illustrates a block diagram of one view of one container as it may look after it was punctured by a handheld puncturing tool.

### DETAILED DESCRIPTION

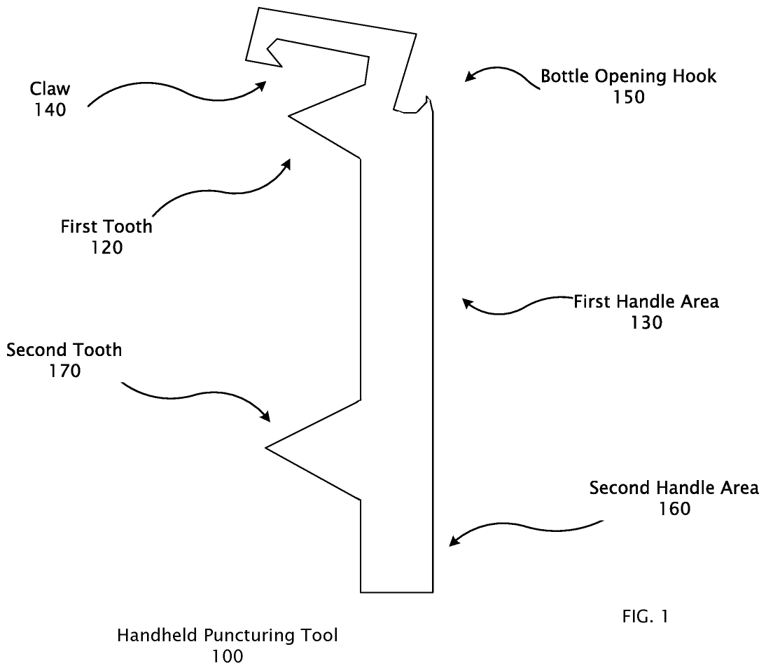

FIG. 1 illustrates a block diagram of one aspect of one embodiment of Handheld Puncturing Tool 100. Handheld Puncturing Tool 100 is made of a single piece, or multiple pieces, of lightweight material with variously shaped prongs, which may include Bottle Opening Hook 150, Claw 140, a First Handle Area 130, a Second Handle Area 160, and at least one First Tooth 120 and one Second Tooth 170. Handheld Puncturing Tool 100 may be made of aluminum metal, stainless steel metal, a blend of metals, or plastics. First Handle Area 130 and or Second Handle Area 160 may be made from the piece of material that the Handheld Puncturing Tool 100 is constructed from, or they may be coated with another material, such as wood or rubber. Handheld Puncturing Tool 100 is a hand operated mechanical tool which may be used to puncture and drain containers, and it may also be used to open bottles with Bottle Opening Hook 150. Handheld Puncturing Tool 100 may be a bottle opening and container puncturing combination tool. An individual user has control over what to use Handheld Puncturing Tool 100 for.

Handheld Puncturing Tool 100 may be made to fit various containers of various shapes and sizes, with relatively flat top or bottom surfaces. Handheld Puncturing Tool 100 may make it extremely easy to open a container without requiring too much force or agility. Claw 140 may be a sharp claw-like shaped prong at one end of Handheld Puncturing Tool 100, which may be used to grip to one end of a container. First Tooth 120 is a sharp prong projected near and below Claw 140. When Handheld Puncturing Tool 100 is used, First Tooth 120 punctures a container to create a venting hole which directs airflow into the container, this reduces the vacuum effect, once Second Tooth 170 pierces the container. Second Tooth 170 is a sharp-ended prong that projects in alignment with and below First Tooth 120. The action of piercing and pressing through the container with Handheld Puncturing Tool 100 is fast and easy for an individual. Both First Tooth 120 and Second Tooth 170 have sharp cutting points that leave a smooth-edged opening in a container after they are pressed into the container. The distance between First Tooth 120 and Second Tooth 170 varies depending on the size of the container that Handheld Puncturing Tool 100 is designed to fit. The length of First Handle Area 130 and Second Handle Area 160 will vary according to the distance between First Tooth 120 and Second Tooth 170.

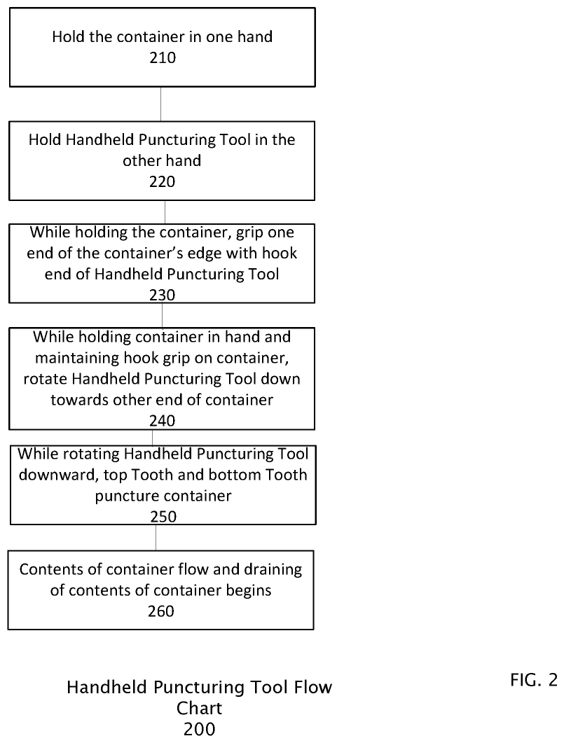

FIG. 2 illustrates one flow chart for the use of a Handheld Puncturing Tool Flow Chart 200. The flow chart outlines steps that may be taken to puncture and drain a container with Handheld Puncturing Tool 100. At Step 210, an individual takes hold of the container that is to be punctured in one hand, exposing the surface of the container which will be punctured to enable draining. Next at Step 220, while the individual has in their one hand the container, the individual takes hold of Handheld Puncturing Tool 100 in the other hand. Handheld Puncturing Tool 100 is relatively light in weight and easy to operate with one hand. In Step 230, the individual proceeds to get ready to puncture the container. Here, the individual will keep hold of the container in one hand, with hand wrapped around the surface of the container that will not get punctured, and exposing the surface of the container where Handheld Puncturing Tool 100 will pierce and puncture. With a steady hold of the container, the individual uses the other hand to take hold of Handheld Puncturing Tool 100 by one or both of its handle areas, using that hold to bring claw-shaped prong end of Handheld Puncturing Tool 100 to meet and grip the top or bottom surface of the container, hooking the claw-shaped prong end of Handheld Puncturing Tool 100 to the top or bottom surface of the container. At this juncture, the container's top or bottom surface is gripped with the claw-shaped prong end of Handheld Puncturing Tool 100, and Handheld Puncturing Tool 100 is tilted up away from the exposed surface of the container. In Step 240, the individual proceeds to rotate Handheld Puncturing Tool 100. While keeping hold of the container in one hand and maintaining the Handheld Puncturing Tool 100 claw-shaped prong gripped on the container; the individual rotates only Handheld Puncturing Tool 100's bottom-end down towards the exposed surface of the container. As Step 240's motion continues, the individual progresses to Step 250, and punctures the exposed surface of the container. In Step 250, while continuing to rotate Handheld Puncturing Tool 100's bottom-end toward the exposed surface of the container, the first sharp-ended tooth prong and then the second sharp-ended tooth prong of Handheld Puncturing Tool 100 both pierce and puncture the exposed surface of the container. At Step 260, the contents flow smoothly out from the opening created by second sharp-ended tooth prong. The opening created by the first sharp-ended tooth prong creates a venting hole which directs airflow into the container, thereby reducing any vacuum effect, this allows for a smoother pour.

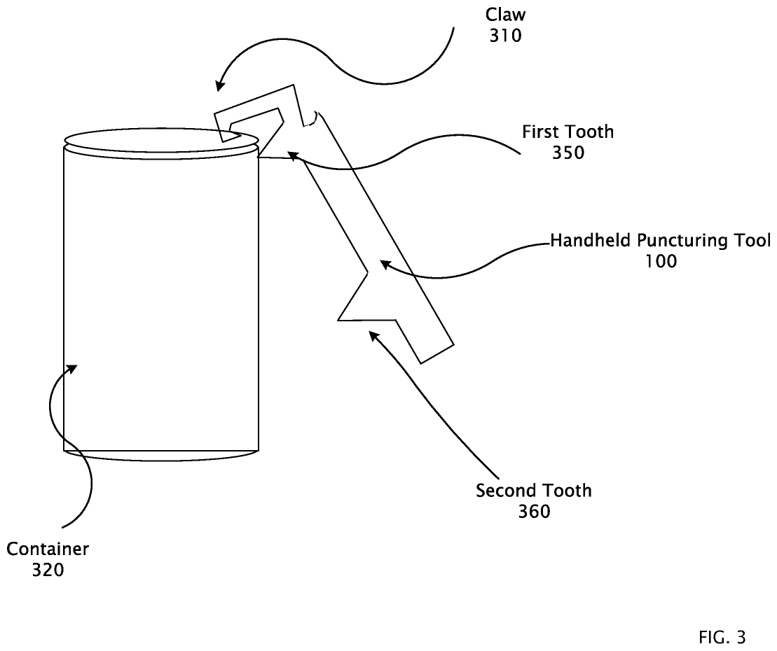

FIG. 3 illustrates a block diagram of one embodiment of a Handheld Puncturing Tool 100 as it may be used on Container 320. Container 320 may be a cylindrical or cube-shaped container with a relatively flat top, bottom, and side surfaces. Container 320 may be made from various materials, such as cardboard, aluminum, or other relatively thin material, that is typically used to store beverages or liquid foods. For example, beverages like soda water, beer, or wine, or liquid foods like tomato juice and chicken broth. Handheld Puncturing Tool 100 may be used by a variety of individuals, such as individuals intending to rapidly consume the contents of Container 320, or individuals such as police officers intending to discard the contents of Container 320 within a short period of time. Following Steps 210 through 260, as described in FIG. 2, an individual would leave exposed a side surface of Container 320, such that Handheld Puncturing Tool 100 will be gripped to one-end of Container 320 with Claw 310, as illustrated here.

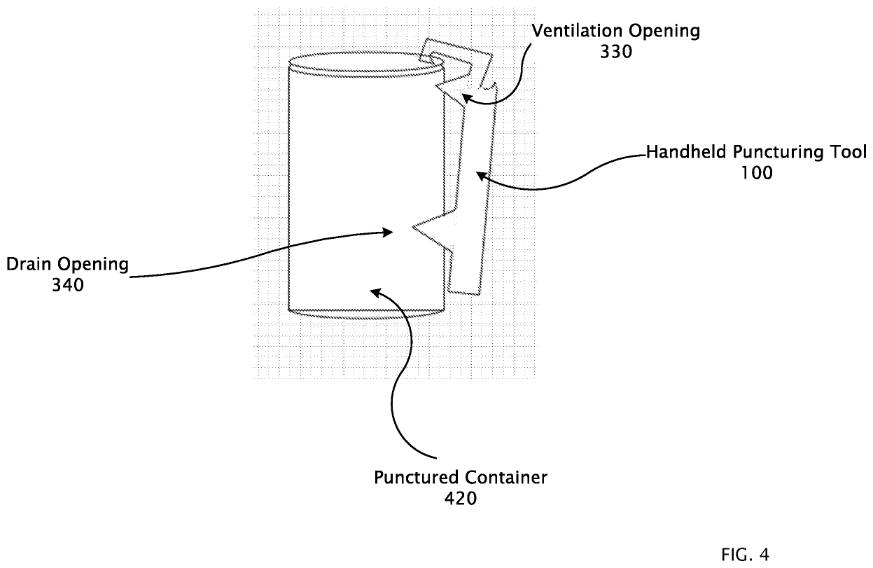

FIG. 4 illustrates a block diagram of one embodiment of a Handheld Puncturing Tool 100 as it may be used on Container 420. Container 420 is shown where Handheld Puncturing Tool 100 has been rotated downward, such that First Tooth 350 and Second Tooth 360 have been simultaneously pressed and punctured Container 320's exposed surface, thereby creating Ventilation Opening 330 and Drain Opening 340. Ventilation Opening 330 is a ventilation hole that reduces any vacuum effect that restricts liquid flow, such that a liquid may be poured or dispensed, rapidly and smoothly from Drain Opening 340.

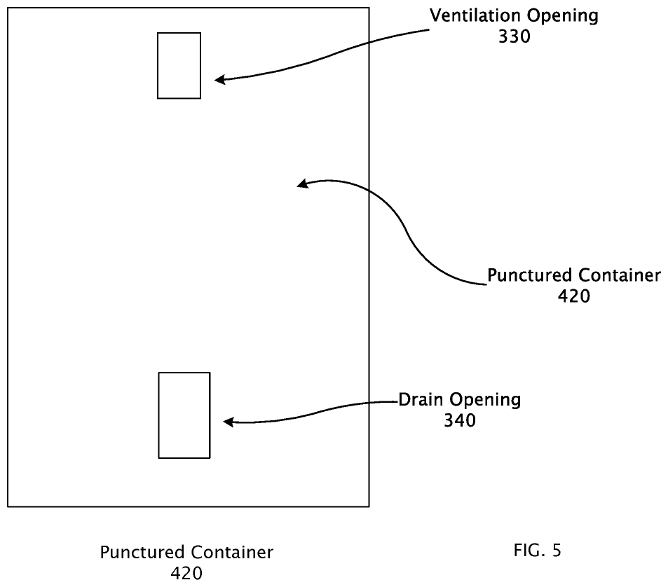

FIG. 5 illustrates a block diagram of one view of Punctured Container 420 as it may look after it was punctured by Handheld Puncturing Tool 100. Here, it can be seen that First Tooth 350 and Second Tooth 360 leave smooth-edged openings. Drain Opening 340 may be safe for an individual to press their mouth to and drink contents from Container 420. An individual may choose to drink directly from Container 420 when they intend to “shotgun” drink beer or soda contents inside Container 420.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A handheld puncturing tool comprising:
an elongated body constructed out of a metal material, a nonmetal material, or a blend of materials;
a claw-shaped prong located at a front end and a first side of the elongated body;
a first sharp-ended tooth prong located at one end of the elongated body below the claw-shaped prong on the first side, wherein the first sharp-ended tooth prong is capable of piercing and puncturing a wall of a metal container; and
a second sharp-ended tooth prong being located along the elongated body below the first sharp-ended tooth, in alignment with the first sharp-ended tooth prong on the first side, wherein the second sharp-ended tooth prong is capable of piercing and puncturing a wall of a metal container.

2. (canceled)

3. (canceled)

4. The handheld puncturing tool of claim 1, wherein a distance between said first sharp-ended tooth prong and second sharp-ended tooth prong is shorter than a length of said elongated body.

5. The handheld puncturing tool of claim 4, wherein said elongated body comprises a hook-shaped prong protruding outward, and wherein the hook-shaped prong is positioned on a second side of the elongated body such that the hook-shaped prong and the claw-shaped prong are parallel.

6. The handheld puncturing tool of claim 5, wherein said elongated body further comprises at least one handle area positioned on the elongated between first sharp-ended tooth prong and second sharp-ended tooth prong.

7. The handheld puncturing tool of claim 6, wherein said elongated body further comprises a second handle area positioned on the elongated body below the second sharp-ended tooth prong.
